(19) United States
(12) Patent Application Publication
(10) Pub. No.: US 2006/0152578 A1
(43) Pub. Date: Jul. 13, 2006

(54) Method of displaying video call image

(75) Inventor: Hee-Jung Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/328,845

(22) Filed: Jan. 10, 2006

(30) Foreign Application Priority Data
Jan. 10, 2005 (KR) 10-2005-0002086

(51) Int. Cl. H04N 7/14

(52) U.S. Cl. 348/14.01

(57) ABSTRACT

Disclosed is a method of displaying a video call image in a video call terminal that displays one of a captured image and an opposite party's image transmitted from an opposite calling party on a whole screen of a display unit and displays the other thereof in a separate window provided on the screen of the display unit. The method includes setting a user's or opposite party's image area that includes user's or opposite party's face and head images by extracting the user's or opposite party's face and head images from the image being displayed on the whole screen, comparing the set user's or opposite party's image area with a display position of the window on the whole screen, and rearranging the image being displayed on the whole screen according to a result of comparison.

### PRIORITY

This application claims priority to an application entitled “Method of Displaying Video Call Image” filed in the Korean Industrial Property Office on Jan. 10, 2005 and assigned Serial No. 2005-2086, the contents of which are hereby incorporated by reference.

### BACKGROUND OF THE INVENTION

1. Field of the Invention

The present invention relates generally to the operation control of a portable terminal having a video call function and a video phone (in the following description, a mobile communication terminal will be explained in priority), and more particularly to a method of displaying a video call image during video calling.

2. Description of the Related Art

Recently, with the advent of an information society, the demand for mobile communication terminals including diverse functions such as camera and video functions in addition to conventional voice functions has increased. Accordingly, many newer mobile communication terminals include high-speed video and data communication functions in addition to conventional voice communication functions. In particular, a camera phone including a digital camera module to implement a digital camera function has recently become commonplace.

Camera phones commonly include a camera module for providing a camera or video function for capturing images such as still images and video images, storing the captured still or video images, and transmitting/receiving the still or video images or other still or video images. Accordingly, camera phones can be used for wirelessly transmitting captured images to other portable terminals via a base station and for storing video data received from the base station, etc. In particular, a video call function using a camera phone has recently been implemented to increase the number of services available to users of the portable terminals.

Unfortunately, when engaging in a video call using a camera phone, an image captured by the phone's camera (hereinafter the captured image or user's image) is typically displayed in a whole portion or substantial portion of the display unit screen and a received image such as a still or video image of the opposite party to the video call (i.e., an opposite party's image) is superimposed upon the captured image. As such, the received image is typically smaller than the captured image.

Alternatively, the captured image can be displayed as a smaller image which is superimposed upon, the received image in which case the captured image is smaller than the received image.

Although a superimposed image can be )positioned on one side of the display unit or may be moved right, left, up or down on the display unit according to a user's setting through a separately provided function-setting menu, blocks a portion of the larger image. A smaller image which is superimposed upon a portion of larger image blocks a portion of the first window.

Thus, when engaging in a video call using the camera phone, when the received image is superimposed upon a larger captured image, it is usually necessary for the camera phone's user to adjust either or both the user's position or the position of the camera phone so that an image of the camera phone's user's face is not hidden by the received image Alternatively, if the captured image is superimposed upon a received image it may be necessary for the opposite party to adjust either or both the opposite party's position or the opposite party's camera so that an image of the opposite party's face is not hidden by the received image.

Thus, when the user's face image (or the opposite party's face image) is hidden, the user (or the opposite party) may have to inconveniently move, adjust his/her posture, and/or reposition the camera phone so that the user's face image and/or the opposite party's face image appears on the display unit.

### SUMMARY OF THE INVENTION

Accordingly, the present invention has been designed to solve the above and other problems occurring in the prior art, and an object of the present invention is to provide a method of displaying a video call image that can make both a user's face image and an opposite party's face image appear on a display unit by adjusting relative positions of the mobile terminal's user's captured image and the opposite party's image being displayed on the display unit while engaged in a video call.

In order to accomplish the above and other objects, there is provided a method of displaying a video call image that grasps a user's face area from a captured image input from a camera, and repositions a user's image for display on a display screen of a terminal in consideration of a display position of an image of an opposite party with whom the user is engaged in the video call so that the user's face image and the opposite party's face image are displayed on the display unit without overlap.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram schematically illustrating a construction of a video call terminal to which the present invention is applied;

FIG. 2 is a screen shot illustrating an example of a captured image displayed on a display unit of FIG. 1 during a video call;

FIGS. 3A to 3C are screen shots illustrating examples of video call images, in which a terminal captured image and an opposite party's image are combined, being displayed on a display unit of FIG. 1;

FIG. 4 is a view illustrating an example of a terminal filmed image for explaining a method of extracting a terminal user's face area displayed on the display unit of FIG. 1 during a video call according to an embodiment of the present invention;

FIGS. 5 and 6 are screen shots showing various examples of video call images illustrating the arrangement of a display position of a user's image on the display unit of FIG. 1 relative to the display position of an opposite party's image during a video call according to an embodiment of the present invention;

FIG. 7 is a view illustrating a storage format of information for newly setting a user's image area stored in a video memory of FIG. 1 according to an embodiment of the present invention; and

FIG. 8 is a flowchart illustrating a video call image display operation performed by the terminal of FIG. 1 during a video call according to an embodiment of the present invention.

### DETAILED DESCRIPTION OF THE PREFERRED EMBODIMENTS

Preferred embodiments of the present invention will be described in detail hereinafter with reference to the accompanying drawings. In the following description of the present invention, a representative embodiment of the present invention will be explained in order to accomplish the above-described objects of the present invention. Although a number of specific features such as detailed constituent elements are given below, they are presented for a better understanding of the present invention only. Also, it will be clear to those skilled in the art that the present invention can easily be practiced without such specific features, or through their modifications.

Additionally, in the following description, for the sake of clarity, it is exemplified that a captured image is displayed using a whole portion of the mobile terminal's display screen that is a display unit, and an opposite party's image is displayed in a separate small window positioned in an upper left or upper right corner of the mobile terminal's display. However, in the present invention, it is also possible to display the opposite party's image (i.e., the received image) over the whole portion of the mobile terminal's display screen and to display the captured image as a relatively small image in the mobile terminal's display.

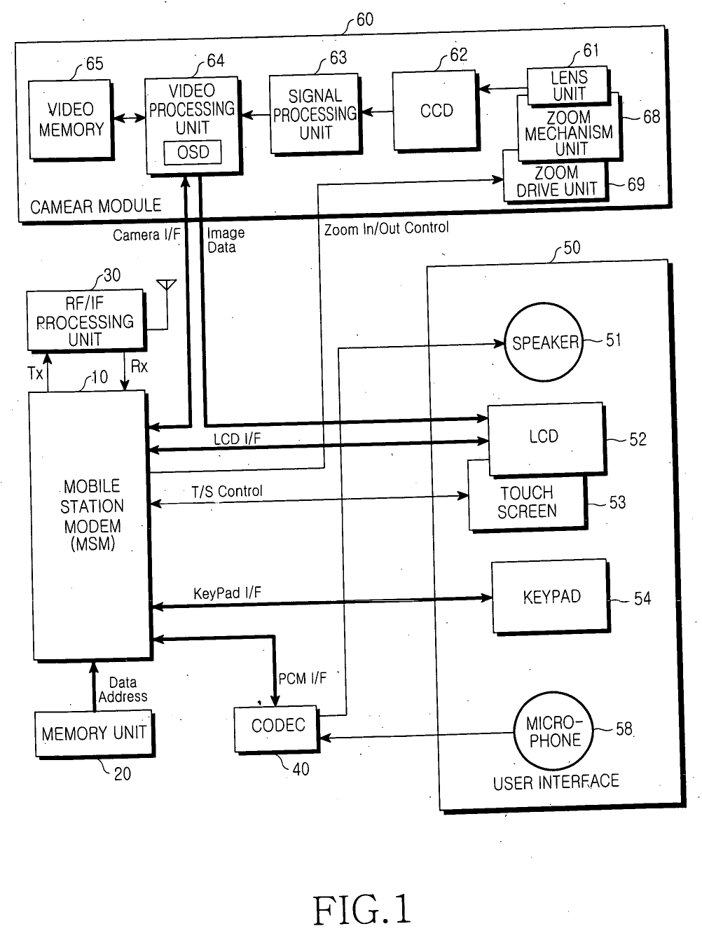

FIG. 1 is a block diagram schematically illustrating a construction of a video call terminal to which the present invention is applied. The video call terminal includes a user interface 50 that operates as an interface with a user and includes a speaker 51, a display unit (e.g., LCD) 52, a key input unit 54, a microphone 58, etc., a camera module 60 that performs a camera function and includes a lens unit 61, a zoom mechanism unit 68, a zoom drive unit 69, an image capturing device (e.g., a Charge Coupled Device (CCD) 62, a signal processing unit 63, a video processing unit 64, a video memory 65, etc., an RF/IF processing unit 30 for performing a wireless signal process, a memory unit 20, composed of a ROM and a RAM, for storing various kinds of operation programs of a mobile communication terminal and operation-related data, an audio signal processing unit 40 for performing an audio signal process, and an MSM (Mobile Station Modem) 10 for performing a role of a central processing unit for controlling the whole operation of the mobile communication terminal and performing a function of a modem.

In the user interface 50, the microphone 58 converts a user's voice into an electric signal and outputs the voice signal to the audio signal processing unit 40. The speaker 51 receives the voice signal from the audio signal processing unit 40 and produces a corresponding audible sound. The key input unit 54 is provided with a plurality of numeral/character keys for inputting numerals and characters and a plurality of function keys for setting various functions for mobile communication, video calls, image functions, etc., and if a predetermined key is input from the user, it provides the corresponding key input data to the MSM 10. The display unit 52 typically includes a liquid crystal display LCD, an LCD controller (not shown), a memory (not shown) for storing video data, etc., and displays text for representing the present state of the mobile communication terminal, user menus, etc., background images, captured images provided from the camera module 60, and other images such as received images, videos, etc. In the present embodiment, an optional touch screen 53 is included on the LCD of the display unit 52.

The RF/IF processing unit 30 includes an RF transmitter for up-converting and amplifying a signal to be transmitted signal, an RF receiver for low-down-converting and amplifying a received signal, etc. The RF/IF processing unit 30 converts a modulated signal received from the MSM 10 into an IF signal, converts the IF signal into an RF signal and transmits the RF signal to a base station through an antenna. Additionally, the RF/IF processing unit 30 receives an RF signal from the base station through the antenna, converts the received RF signal into an IF signal and then into a baseband signal, and then provides the baseband signal to the MSM 10.

The audio signal processing unit 40 typically includes an audio codec. The audio signal processing unit 40 converts an analog audio signal received from the microphone 58 into a digital audio signal, such as a pulse code modulation (PCM) audio signal, and then sends the converted digital audio signal to the MSM 10, or converts an opposite calling party's (i.e., a received) digital (PCM) audio signal input from the MSM 10 into an analog signal and sends the converted analog audio signal to the speaker 51. Although this audio signal processing unit 40 is illustrated as a separate function block, it may be integrated with the MSM 10 on a single chip.

The MSM 10 performs various functions of the mobile communication terminal according to the key data input from the key input unit 54, and causes the display unit 52 to display information about the present state of the mobile communication terminal and user menus. Particularly, in the case of processing the audio signal for a video call, the MSM 10 converts the PCM audio signal received from the audio signal processing unit 40 through channel coding and interleaving processes, modulates the converted audio signal and provides the modulated audio signal to the RF/IF processing unit 30, while it converts the video and audio signals received from the RF/IF processing unit 30 into a PCM audio signal and video data through processes of demodulation, equalization, channel decoding and deinterleaving, and sends the PCM audio signal and the video data to the audio processing unit 40 and the video processing unit 64, respectively.

In the camera module 60, the lens unit 61 receives an image of an object. This lens unit 61 includes at least one lens for receiving and focusing the image upon an image capturing device 62. An optional zoom mechanism unit 68, is provided for enabling a zoom function for enabling an image to be zoomed in/out. Zoom lenses are installed in the zoom mechanism 68 that includes a plurality of optional gears and/or moving devices for properly focusing images and/or adjusting the positions of the zoom lenses during the zoom in/out operation. The zoom drive unit 69 includes a motor and a transfer device for transferring a driving force of the motor to the zoom mechanism unit 68, and drives the zoom mechanism unit 68 to properly zoom in/out the lens unit 61 under the control of the MSM 10. In the lens unit 61, the incident light propagates to the image capturing device 62, which includes a CCD or a Complementary Metal Oxide Semiconductor (CMOS) or other image capturing elements as is commonly known in the art. The image capturing device 62 converts the image received through the lens unit 61 into an electric signal having luminance and colors of red, green and blue to output the converted signal. The signal processing unit 63 includes a Digital Signal Processor (DSP) that performs a Correlated Double Sampling/Auto Gain Control (CDS/AGC) of the signal output from the image capturing device 62 and converts the CDS/AGC-processed signal into a digital signal. The video processing unit 64 forms an NTSC (National Television System Committee) or a PAL (Phase Alternation by Line) type video data by performing video processing such as a gamma correction, a color correction, etc., of the signal output from the signal processing unit 63 and provides the NTSC or PAL type video signal to the display unit 52. The video processing unit 64 processes the output signal of the signal processing unit 63 in the unit of a frame, and outputs the video data in the unit of a frame to match the characteristic of the display unit 52 and the size of the LCD. The video processing unit 64 is provided with a video codec, and compresses the frame video data displayed on the display unit 52 using a predetermined method or restores the compressed frame video data to the original frame video data. Here, the video codec may be a JPEG (Joint Photographic Experts Group), an MPEG4 (Moving Pictures Expert Group 4) codec, a wavelet codec, etc. Additionally, the video processing unit 64 has an OSD (On Screen Display) function, and adds OSD data to the video data output to the display unit 52 under the control of the MSM 10. Additionally, the video processing unit 64 performs a proper process of the user's image and an addition of the user's image to the opposite party's image during a video call according to the present invention.

The video memory 65 is used as a memory for temporarily storing data required for the video processing operation and as a built-in memory for storing captured or other image data. The video memory 65 may also store captured images and received images such as an opposite party's images used for the video calling according to the present invention.

The operation of the mobile communication terminal having the above-described construction illustrated in FIG. 1 will now be explained in further detail.

If the user sets a calling mode after performing a dialing using the key input unit 54, the MSM 10 detects this, processes the dial information, and then sends a wireless calling signal through the RF/IF processing unit 30. Thereafter, a speech path is formed so that an opposite party's response signal that is received through the RF/IF processing unit 30 is output to the speaker 51 through the audio signal processing unit 40. In a destination mode, the MSM 10 detects the destination mode through the RF/IF processing unit 30, and causes the audio signal processing unit 40 produce a ring signal. Then, the MSM 10 detects a user's response and forms a speech path through the audio signal processing unit 40 in the same manner.

Meanwhile, in a video calling mode, the MSM 10 operates the camera module 60, adds the opposite party's image transmitted from the opposite party's terminal to the captured image obtained by the camera module 60, and controls the display unit 52 to display the added opposite party's image. Hereinafter, the above-described operation will be explained in more detail with reference to the accompanying drawings.

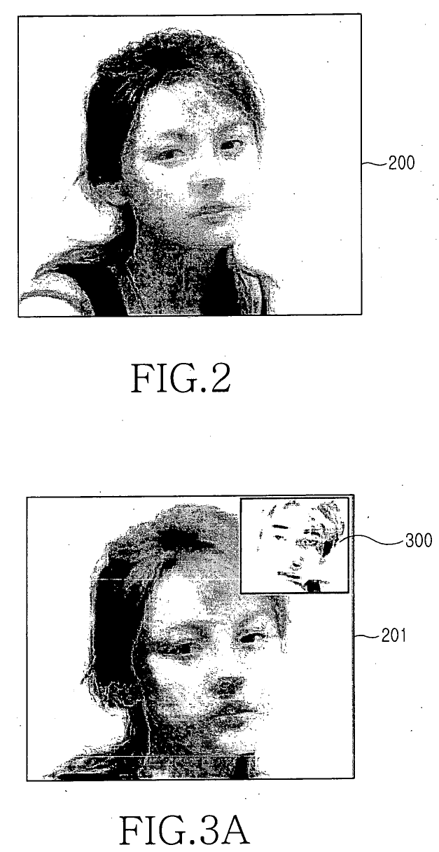

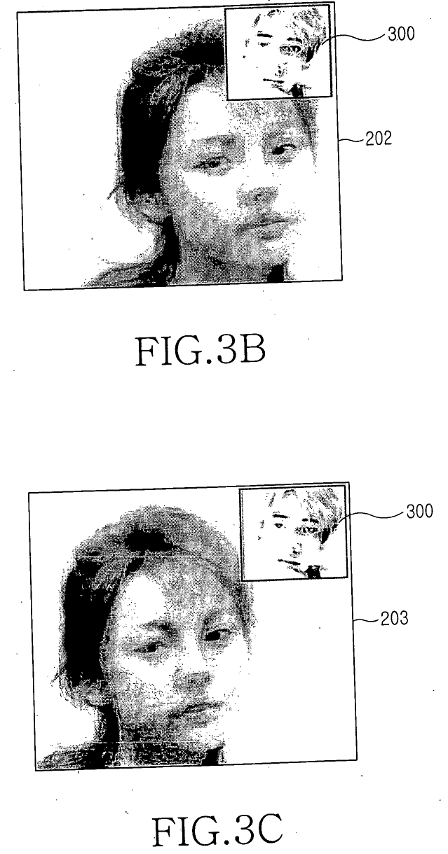

FIG. 2 is a screenshot illustrating an example of a filmed image being displayed on a display unit of FIG. 1 during a video call, and FIGS. 3A to 3C are screenshots illustrating examples of video call images, in which a user's image and an opposite party's image are combined, and displayed on the display unit of FIG. 1. Referring to FIGS. 1 and 3A to 3C, the camera phone's user can watch the opposite party's image 300 together with the user's captured image 200 through the display unit 52 during the video call. Generally, during the video call, the user captures the user's own image using the camera phone which is held in the user's hand, and thus an image of the user's face occupies a large part of the display screen as shown in FIG. 2.

In FIGS. 3A and 3B, a part of the user's captured image 201 or 202 being displayed over the whole display unit 52 is hidden by the opposite party's image 300 which is displayed in the upper right corner of the display unit 52. If the opposite party's image 300 is displayed in the upper right corner of the display unit 52, the user's face image 201 or 202 that is positioned in the center of the display unit 52 (See FIG. 3A) or slants to the right of the display unit 52 (See FIG. 3B) is partly hidden by the opposite party's image 300, and thus the user cannot view the hidden part of the user's own image.

FIG. 3C illustrates the displayed filmed image 203 that slants to the left of the display unit 52. In this case, the image of the user's face is not hidden by the opposite party's image 300. In the embodiment of the present invention, if the opposite party's image is displayed on the upper right corner of the display unit as shown in FIGS. 3A and 3B, the image of the user's face displayed on the display unit 52 is entirely moved to the left of the display unit 52 as shown in FIG. 3C.

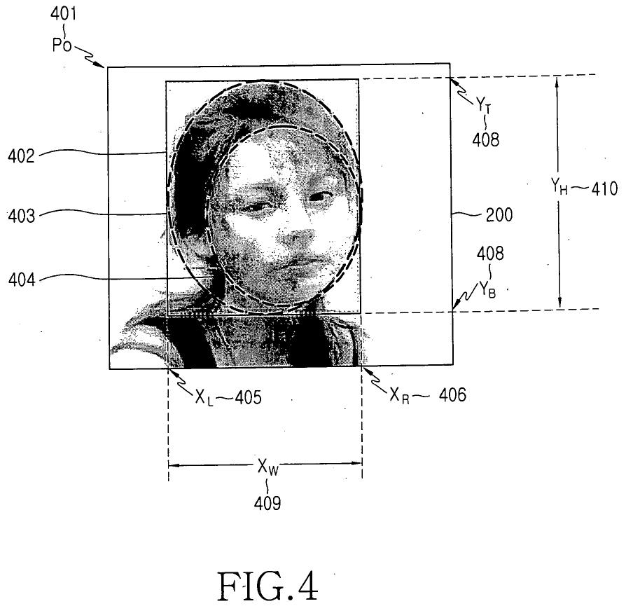

FIG. 4 is a view illustrating an example of a captured image 200 for explaining a method of extracting a terminal user's face area displayed on a display unit of FIG. 1 during a video call according to an embodiment of the present invention. A face area 404 is extracted from the captured image 200 input from the camera module 60 by detecting the edge of the user's face and a color difference between the user's face and the neighboring image. Then, a head area 403 that includes a hair area and the face area 404 is extracted by searching for the hair area using the color difference in the same manner as the face area detection. Then, a tetragonal area obtained by connecting edges of the extracted head area 403 is set as a user's image area 402. If the user's image area 402 is set, coordinate values of respective comers of the user's image area 402 are obtained on the assumption that the upper left corner of the captured image is set as a reference point [0,0] and horizontal and vertical directions are represented as X and Y axes. In this case, the coordinate values of the upper left corner, lower left corner, upper right corner and lower right corner of the user's image area 402 become [X_{L}, Y_{T}], [X_{L}, Y_{B}], [X_{R}, Y_{T}] and [X_{R}, Y_{B}], respectively. Also, the width and the height of the user's image area 402 become X_{W} and Y_{H}, respectively.

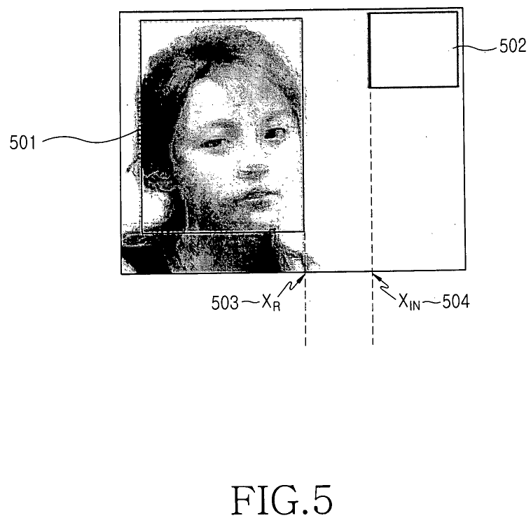

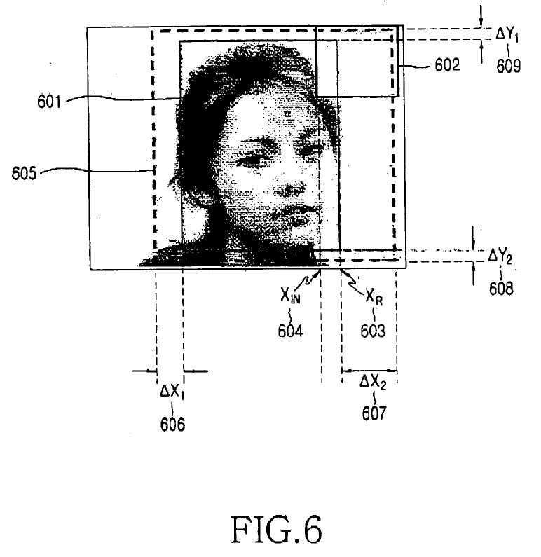

FIGS. 5 and 6 are views illustrating examples of video call images for explaining the arrangement of the user's image display position on the display unit of FIG. 1 in consideration of the opposite party's image display position during the video call according to an embodiment of the present invention. FIG. 5 shows the user's face image that slants to the left of the display unit 52 as illustrated in FIG. 3C. In this case, by comparing a right coordinate value (X_{R}) 503 of a user's image area 501 that includes the hair part and the whole face of the user with a left coordinate value (X_{IN}) 504 of an opposite party's image area 502 during the video calling, it can be determined that the value of X_{IN} is greater than the value of X_{R}. That is, it can be determined that the user's face image is not hidden by the opposite party's image during the video calling.

FIG. 6 shows the user's face image that is positioned in the center of the display unit 52 or slants to the right of the display unit 52 as shown in FIG. 3A or 3B. In this case, by comparing a left coordinate value (X_{R}) 603 of a user's image area 601 that includes the hair part and the whole face of the user with a left coordinate value (X_{IN}) 604 of an opposite party's image area 602 during the video call, it can be determined that the value of X_{IN} is the value of X_{R}. That is, it can be determined that the user's face image is partly hidden by the opposite party's image during the video call. In this case, the user's face image area 601 may be moved to the left of the display unit 52 so that the user's face image is not hidden by the opposite party's image. In the present invention, a new user's image area 605 is set around the user's face, and only the new user's image area 605 is moved to the left of the display unit 52. For this, information (ΔX₁, ΔX₂, ΔY₁, ΔY₂) about the new user's image area 605 is received from the video memory 65, and then the new user's image area 605 is set on the basis of the user's image area 601 set around the user's face. The new user's image area 605 is set by expanding upper, lower, right and left areas on the basis of the existing user's image area 601, and the length ΔX₂ expanding to the right is larger than the length ΔX₁ expanding to the left. By moving the created user's image area 605 to the left after setting the lengths ΔX₁ and ΔX₂, the user's image appears to shift to the left of the display unit 52. In this case, the information (ΔX₁, ΔX₂, ΔY₁, ΔY₂) about the new user's image area 605 to be newly set is properly set according to the whole size of the screen and the size of the user's face area. Then, the new user's image area 605 that has moved to the left of the display unit 52 is enlarged to match the width and the height of the display unit 52. Accordingly, the user's image [shifts?] to the left side of the display unit 52, and thus does not overlap the opposite party's image 602.

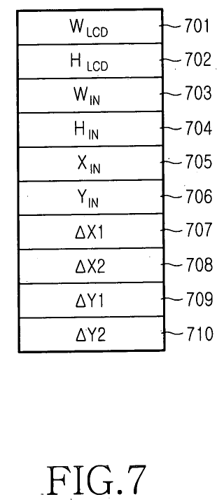

FIG. 7 is a view illustrating a storage format of information for newly setting the user's image area stored in the video memory 65 according to an embodiment of the present invention. Referring to FIG. 7, information included in the video memory 65 includes information (ΔX₁, ΔX₂, ΔY₁ and ΔY₂) 707, 708, 709 and 710 required to set the new user's image area 605 that is used to shift the user's image to the left of the display unit 52 on the basis of the user's image area 601 set around the user's head that includes the user's hair part and face, information (W_{LCD}, H_{LCD}) 701 and 702 about the maximum size of the image to be displayed on the display unit 52, information (W_{IN}, H_{IN}) 703 and 704 about the size of a window for displaying the opposite party's image, and window position information (X_{IN}, Y_{IN}) 705 and 706.

W_{LCD} 701 and H_{LCD} 702 represent the width and the height of the maximum image that can be displayed on the display unit 52. W_{IN} 703 and H_{IN} 704 represent the width and the height of a small window for displaying the opposite party's image. X_{IN} 705 and Y_{IN} 706 represent the X and Y coordinate values of the upper left corner of the small window for displaying the opposite party's image. The small window for displaying the opposite party's image has the width of W_{IN} 703 and the height of H_{IN} 704, and the coordinate value of its upper left corner is (X_{IN}, Y_{IN}). ΔX₁ 707 represents the length expanding to the left, and ΔX₂ 708 represents the length expanding to the right. In the event that the opposite party's image is displayed on the right side of the display unit 52, more extra space is required on the right of the display unit 52 on the basis of the user's face area. Accordingly, the value of ΔX₂ is greater than the value of ΔX₁. ΔY₁ represents the length expanding upward, and ΔY₂ represents the length expanding downward.

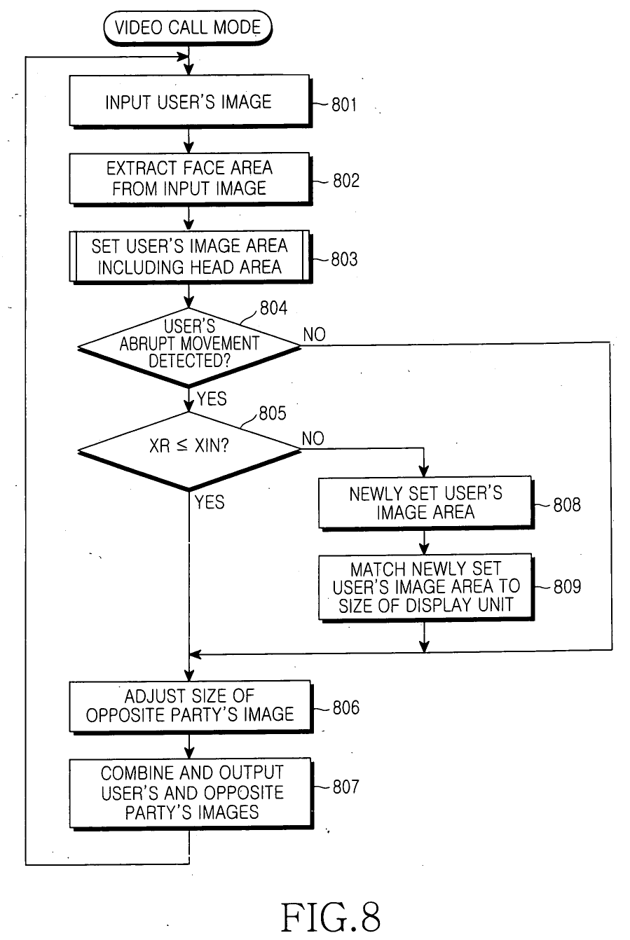

FIG. 8 is a flowchart illustrating the video call image display operation performed by the terminal of FIG. 1 during the video call according to an embodiment of the present invention. In the video calling mode, the user's image is captured and input by the camera module 60 at step 801.

Then, the face area 404 is extracted using the color difference between the skin and the neighborhood from the filmed image and the face edge at step 802. Then, the head area 403 that includes a hair area, which has a color darker than that of the face, and the face area 404 is extracted with reference to the detected face area at step 803, and then the user's image area 402 around the head area is set on the basis of the extracted head area.

Then, it is determined whether there is any substantial movement in the captured image (e.g., movement caused by moving the camera phone or by the user moving) by confirming whether the position of the user's image in the currently captured image substantially changed from the average position of the previous captured image at step 804. The user's relative location is determined so that only images in which a user's position has changed can be processed without having to process all the captured images because the image processing such as the face area extraction processing requires a great deal of processing time and effort.

When a first image is initially captured and processed, there are no filmed images to be compared with so in this case, it is determined that the user has not substantially moved at step 804, and then step 806 proceeds. At step 806, the video processing unit 64 receives the opposite party's image transferred through the mobile communication network from the MSM (Mobile Station Modem) 10, converts the opposite party's image to a predetermined size 705 and 706 according to the preset window, and then proceeds to step 807 to display the opposite party's image on a predetermined position 602 of the display unit 52 together with the user's image. Then, the present step returns to step 801 to repeat the receiving and processing of the filmed image.

At step 803, the center point of the user's image area 402 is searched for and the position difference between the center point of the present user's image area and the center point of the previous user's image area is calculated whenever the user's image area 402 is set. In this manner, the corresponding step is repeatedly performed for a predetermined time, i.e., for T seconds, and an average changed distance of the center position of the user's image area 402 for the previous T seconds is calculated. At step 804, if the position difference between the center point of the user's image area extracted from the newly filmed image and the center point of the user's image area extracted from the previously filmed image is larger than the previously calculated average distance difference for T seconds, it is determined that the image contains the user's substantial movement, and then step 805 proceeds.

At step 805, the right X coordinate value X_{R} 603 of the user's image area 601 set around the user's head is compared with the left X coordinate value X_{IN} 604 of the window for displaying the opposite party's image. If the value of X_{R} is less than the value of X_{IN} as a result of comparison, step 806 proceeds, while if the value of X_{R} is greater than the value of X_{IN}, that is, if the user's image area around the user's head overlaps the window for displaying the opposite party's image, step 808 proceeds. At step 808, the user's image area is newly set so that the two images do not overlap each other. For this, the new user's image area 605 that is larger than the previously set user's image area 601 around the user's head using the values 707 to 710 stored in the video memory 65. Then, at step 809, the newly set user's image area 605 is shifted to the left of the display unit 52, the shifted user's image area is enlarged to match the size of the display unit 52, and then step 807 proceeds. At that time, the newly set user's image area is shifted to the left of the display unit 52 as far as Xcorr through calculation as expressed by Equation 1.
W_{LCD}:ΔX₁+X_{R}−X_{L}+ΔX₂=W_{LCD}−(ΔX₁+(X_{IN}−X_{L})+W_{IN}):Xcorr Equation 1.

As described above, according to the method of displaying a video call image according to the present invention, the position of the user's face image is detected and rearranged in the image filmed by the camera module, and thus the blocking of the user's image by the opposite party's image due to the user's frequent movement can be reduced to improve the quality of a video call.

While the present invention has been shown and described with reference to certain preferred embodiments thereof, it will be understood by those skilled in the art that various changes in form and details may be made therein without departing from the spirit and scope of the present invention. For example, although in the embodiment of the present invention, the window for displaying the opposite party's image is provided on the upper right corner of the display unit, it may also be provided on the lower right corner or on the upper/lower left corner of the display unit, so that the position of the user's image is rearranged to prevent the user's image from being hidden by the opposite party's image on the display unit. In addition, various modifications and variations can be made in the present invention, and thus it is intended that the present invention covers the modifications and variations of this invention provided they come within the scope of the appended claims and their equivalents.

What is claimed is:

1. A method of displaying a video call image in a video call terminal by displaying one of a captured image and an opposite party's image transmitted from an opposite party on a whole screen of a display unit and displaying the other thereof in a separate window provided on the screen of the display unit, the method comprising the steps of:
setting a user's or opposite party's image area that includes the user's or opposite party's face and head images by extracting the user's or opposite party's face and head images from the image being displayed on the whole screen;
comparing the set user's or opposite party's image area with a display position of the window on the whole screen; and
rearranging the image being displayed on the whole screen according to a result of comparison.

2. The method as claimed in claim 1, wherein the user's or opposite party's image area is set as a tetragonal area obtained by connecting edges of the extracted head image area.

3. The method as claimed in claim 1, wherein the step of comparing the set user's or opposite party's image area with the display position of the window on the whole screen comprises confirming whether the user's or opposite party's image area and the display position of the window overlap each other.

4. The method as claimed in claim 1, wherein the step of rearranging of the image being displayed on the whole screen according to the result of comparison comprises expanding the user's or the opposite party's image area in the image being displayed on the whole screen of the display unit according to a preset value so that an expansion value in a direction of the window is larger than an expansion value in a direction opposite to the direction of the window and enlarging of the expanded image area to match the whole screen.

5. The method as claimed in claim 1, wherein the image displayed on the whole screen is the captured image, and the image displayed in the window is the opposite party's image.

6. The method as claimed in claim 2, wherein the image displayed on the whole screen is the captured image, and the image displayed in the window is the opposite party's image.

7. The method as claimed in claim 3, wherein the image displayed on the whole screen is the captured image, and the image displayed in the window is the opposite party's image.

8. The method as claimed in claim 4, wherein the image displayed on the whole screen is the captured image, and the image displayed in the window is the opposite party's image.

9. The method as claimed in claim 1, wherein the position of the window in the whole screen is any one of an upper right corner, a lower right corner, an upper left corner and a lower left corner of the screen.

10. The method as claimed in claim 2, wherein the position of the window in the whole screen is any one of an upper right corner, a lower right corner, an upper left corner and a lower left corner of the screen.

11. The method as claimed in claim 3, wherein the position of the window in the whole screen is any one of an upper right corner, a lower right corner, an upper left corner and a lower left corner of the screen.

12. The method as claimed in claim 4, wherein the position of the window in the whole screen is any one of an upper right corner, a lower right corner, an upper left corner and a lower left corner of the screen.

13. A method of displaying a video call image in a video call terminal that displays one of a captured image and an opposite party's image received from opposite party on a whole screen of a display unit and displays the other thereof in a separate window provided on the screen of the display unit, the method comprising the steps of:
setting a user's or opposite party's image area that includes user's or opposite party's face and head images by extracting the user's or opposite party's face and head images from images being successively processed to be displayed on the whole screen, and determining whether the user's or opposite party's image has a movement more than a preset reference value;
if the user's or opposite party's image has the movement more than the present reference value as a result of determination, comparing the set user's or opposite party's image area with a display position of the window on the whole screen; and
rearranging the image being displayed on the whole screen according to a result of comparison.

14. The method as claimed in claim 13, wherein the step of determining whether the user's or opposite party's image has the movement more than the preset reference value comprises calculating of an average position of the user's or opposite party's image area for a previous reference time preset during the setting of the user's or opposite party's image area, and determining whether a most recently set position of the user's or opposite party's image area deviates from the average position by more than the preset reference value.

15. The method as claimed in claim 14, wherein the step of calculating the average position of the user's or opposite party's image area further comprises calculating of a position difference between center points of the user's or opposite party's image area.

16. The method as claimed in claim 13, wherein the user's or opposite party's image area is set as a tetragonal area obtained by connecting edges of the extracted head image area.

17. The method as claimed in claim 13, wherein the step of comparing the set user's or opposite party's image area with the display position of the window on the whole screen comprises determining whether the user's or opposite party's image area and the display position of the window overlap each other.

18. The method as claimed in claim 13, wherein the step of rearranging of the image being displayed on the whole screen according to the result of comparison expanding of the user's or opposite party's image area in the image being displayed on the whole screen according to a preset value so that an expansion value in a direction of the window is larger than an expansion value in a direction opposite to the direction of the window and enlarging of the expanded image area to match the whole screen.

19. The method as claimed in claim 13, wherein the image being displayed on the whole screen is the captured image, and the image being displayed in the window is the opposite party's image.

20. The method as claimed in claim 13, wherein the position of the separate window in the whole screen is any one of an upper right corner, a lower right corner, an upper left corner and a lower left corner of the screen.
